(19) United States
(12) Patent Application Publication
(10) Pub. No.: US 2005/0239645 A1
(43) Pub. Date: Oct. 27, 2005

(54) Thermally stabile materials having high specific surfaces

(76) Inventors: Ferdi Schuth, Mulheim an der Ruhr (DE); Manfred Schwickardi, Mulheim an der Ruhr (DE); Wolfgang Schmidt, Mulheim an der Ruhr (DE); Alfred Haas, Eppelheim (DE)

Correspondence Address: NORRIS, MCLAUGHLIN & MARCUS, PA, 875 THIRD STREET, 18TH FLOOR, NEW YORK, NY, 10022, US

(21) Appl. No.: 10/517,683

(22) PCT Filed: Jun. 11, 2003
(86) PCT No.: PCT/DE03/01969

§ 371 Date: Dec. 10, 2004

(30) Foreign Application Priority Data
Jun. 12, 2002 (DE) 102 26 131.8

(51) Int. Cl. B01J 21/18

(52) U.S. Cl. 502/405; 502/180; 502/182; 502/183; 502/185

(57) ABSTRACT

The invention relates to materials which are stable at high temperatures and which have high specific surfaces. Said materials are produced by heating them to a temperature in a matrix above the later temperature at which they are used, e.g. aluminum oxide or zirconium oxide. The temperature of the specific surfaces thereof, after relatively long tempering, is 1100° C. or 1000° C., even above 50 m²/g or 10 m²/g. Carrier catalysts can be also be produced according to said method.

The present invention describes thermally stable materials having high specific surface areas, and a method for production thereof.

Materials having high specific surface areas are of great technical importance in many sectors. For instance, aluminum oxides and zirconium oxide-based materials, for example, are used as washcoats in automobile exhaust catalysts to achieve high dispersion of the noble metal component (E. S. J. Lox, B. H. Engler, Handbook of Heterogeneous Catalysis, Wiley VCH, Weinheim 1997, 1559 ff). For chemistry catalysts also, high specific surface areas are of great importance to ensure a highest possible activity for the catalyzed reaction.

For instance, oxides having specific surface areas of about 100 m²/g can be obtained by precipitation or coprecipitation of the corresponding hydroxides from salt solutions and subsequent calcination [M. Daturi et al., J. Phys. Chem. 2000, 104, 9186, M. F. L. Johnson, J. Mooi, J. Catal. 1968, 10, 342; G. K. Chuah, et al. Micoropor. Mesopor. Mater. 2000, 37, 345; M. A. Valenzuela et al., Appl. Catal. A: General 1997, 148, 315; G. Busca et al., Chem. Mater. 1992, 4 595; A. Alejandre et al., Chem. Mater. 1999, 11, 939; R. Roesky et al., Appl. Catal. A: General 1999, 176, 213; J. M. Lee et al. U.S. Pat. No. 4,446,201 1984]. Higher specific surface areas 100-300 m²/g are achievable if corresponding precursor phases are produced by sol-gel processes before the calcination, customarily alkoxides or other organic metal compounds being used [A. C. Pierre et al., Langmuir 1998, 14, 66; E. Elaouli et al., J. Catal. 1997, 166, 340; Y. Mizushima, M. Hon, J. Mater. Res. 1993, 8, 2993; K. Maeda et al. J. Chem. Soc. 1992, 88, 97; M. A. Valenzuela et al., Appl. Catal. A: General 1997, 148, 315; C. Otero Aréan et al., Mater. Lett. 1999, 39, 22; G. Busca et al., Catal. Today 1997, 33, 239-249; E. Escalona Platero et al., Res. Chem. Intermed. 1999, 25, 187]. The size of the specific surface areas is determined by the particle size of the oxides formed, with smaller particles, based on the weight of the sample, resulting in larger surface areas.

However, the materials which are used for the abovementioned applications typically lose their high specific surface areas by sintering processes or phase transitions under high-temperature treatments, as can occur, for instance, in automobile exhaust gas under long full-load operation, which highly adversely affect their service properties (E. S. J. Lox, B. H. Engler, Wiley-VCH, Weinheim 1997, Handbook of Heterogeneous Catalysis, 1615). There is therefore an interest in developing materials, the high specific surface area of which is retained even at high temperatures.

Methods are known for producing oxides of high specific surface area, for example of ZrO₂ or CeO₂ZrO₂, in which the materials are produced from a precursor in the pores of a matrix, for example activated carbon or cellulose [M. Ozawa, M. Kimura, J. Mater. Sci. Lett. 1990, 9, 446; A. N. Shigapov et al., Appl. Catal. A, General, 2001, 210, 287]. Aluminates can also be formed by thermal treatment of ion-exchanged zeolites. Calcining transition metal-exchanged zeolites produces spinel particles in a silicate matrix which, after dissolution of the matrix, have surface areas up to 200 m²/g [W. Schmidt, C. Weidenthaler, Chem. Mater. 2001, 13, 607; T. Ogushi, JP 62-265114A, 1988].

Zeolites have also been produced in the pores of activated carbons (C. Madsen, C. J. H. Jacobsen, Chem. Commun. 1999, 673) or activated carbons have been used in a complex method as exotemplates utilizing supercritical fluids for the synthesis of nanoparticles (H. Wakayama et al. Chem. Mater. 2001, 13, 2392). In all mentioned routes based on activated carbons or cellulose, the matrix, however, is removed by combustion without further measures, as a result of which the materials produced have no particular thermal properties.

For instance, the oxide, according to the method of Ozawa and Kimura [M. Ozawa, M. Kimura, J. Mater. Sci. Lett. 1990, 9, 446] is formed in the combustion of the activated carbon at temperatures which are in the range of the later service temperatures or even below. The oxides produced in this manner typically sinter at temperatures which are above the combustion temperature of the carbon, as a result of which their specific surface areas are drastically decreased. A similar situation applies to the particles which are formed from zeolite precursors, which particles at relatively high temperatures or relatively long thermal treatment grow to very large crystallites in the silicate matrix, as a result of which their specific surface area is drastically decreased aleady at their formation [C. Weidenthaler, W. Schmidt, Chem. Mater. 2000, 12, 3811]. The matrix, in this method, does not have a limiting action on particle growth.

The object underlying the present invention was to produce a method for producing materials having high surface areas, which materials have a thermal stability such that the surface area changes scarcely or only very little, compared with the materials known from the prior art at their service temperature.

It has now surprisingly been found that sintering and phase transition can be avoided at high temperatures if the materials are already treated in their production at temperatures which are above the later service temperature.

The present invention therefore relates to a method for producing a material having a high specific surface area at high service temperature, the material, embedded in a matrix, being produced by thermal pretreatment, and the matrix then being removed, characterized in that the thermal pretreatment comprises heating to a temperature which is above the service temperature.

The thermal pretreatment is here preferably performed in a matrix in which the particles of the material or precursor thereof are enclosed in such a manner that sintering is prevented. Such a matrix is preferably selected from materials which may again be removed chemically or physically after the formation of the material of high specific surface area produced according to the invention. Suitable examples of matrix materials can be selected, for example, from finely divided carbonaceous materials, such as activated carbon and ordered carbons, and/or from silica gels, in particular ordered silica gels.

The matrix materials can be removed, for example, by reaction with a reactive gas, such as by converting these materials into gaseous compounds, for example when the reactive gas is oxygen, by combustion, or by dissolving the matrix materials by suitable agents, for example using strong acids or alkali solutions. If a carbonaceous material is used as matrix, the combustion to give CO₂ has proved a suitable method for removal thereof. Silica gels and similar materials can be removed, for example, by dissolution with strong acids or alkali solutions, such as HF or NaOH.

In a preferred embodiment, the precursor for the material having a high specific surface area is applied to the matrix material, that is to say it is enclosed in its pores. The precursor is then transformed or converted into the material to be produced. Preferably, the precursor is such a material or has such a composition that, at high temperatures, the material to be produced forms. If, for example, metal oxides are to be produced, the precursor used can be, for example, nitrates thereof which, at elevated temperatures, transform into the oxides. The material to be produced is, according to the invention, heated in the presence of the matrix material to a temperature which is above the later service temperature. A good thermal stability of the resultant materials is achieved when thermal treatment is at a temperature more than 100° C. above the later service temperature. Preferably, the thermal treatment is performed over a period such that the surface area of the material to be produced does not change at all, or changes as little as possible.

For the production of the inventive materials, first a thermal pretreatment is carried out under protective gas at very high temperatures, markedly (50° C., better 100° C. or more) above the later service temperature of the materials, to avoid premature combustion of the matrix material, for example the activated carbon matrix. It has been found that as a result of the very high temperatures during the treatment, the materials produced in the matrix are passivated. It is also possible to produce the thermodynamically most stable phases. After the thermal pretreatment, the matrix material, such as activated carbon, can be burnt off at lower temperatures under a reactive gas atmosphere, for example in the presence of oxygen, as a result of which the desired material remains behind. If silica gels are used as matrix materials, these can be dissolved, for example, with HF or NaOH, and thus removed. The description of this methodology is intended only to illustrate the procedure by way of example, and in no way to restrict it. Matrices other than activated carbon can also be used, or methods other than calcination can be used for matrix removal. To produce ordered thermally stable oxides, it has proved to be preferred to use matrix materials having what is termed an ordered pore structure, that is to say materials having a pore structure as uniform as possible. Examples which may be mentioned are, for example, ordered carbons such as CMK-1, SNU-1, or silica materials, such as CMK-3, or ordered silica gels, such as SBA-15 or MCM-48. Those skilled in the art are able here to make an appropriate method and material selection. By selecting appropriate matrix materials it is possible to set the particle size of the inventively available particles, in particular to set an upper limit. The material having a high specific surface area preferably has a high thermal stability, so that it can be used in processes which are carried out at high temperatures. Examples of such materials are metal oxides. In particular the materials produced according to the invention are preferably oxides having high melting points, for example above 1500° C. Oxides which can be used are oxides of the elements Be, Mg, Ca, Sr, Ba, Al, Ga, Si, Mg, Ca, Sc, Y, La, Ti, Zr, Hf, V, Cr, Mn, Fe, Co, Ni, Zn, U, Th and the lanthanides or mixtures thereof. The oxides produced according to the invention preferably have a surface area greater than 10 m²/g, in particular greater than 50 m²/g. It is possible to produce, for example, γ-aluminum oxide which, even after thermal treatment for a period of 3 h at 1100° C. in the presence of air, has a specific surface area of at least 50 m²/g. Zirconium oxides can verify reference examples that the surface areas which are achievable using conventional methods, that is to say without high-temperature treatment, are markedly smaller. In addition, it is possible to obtain ZrO₂ and oxide mixtures having a molar fraction of ZrO₂ greater than 50% which, after thermal treatment in air at 1000° C. for a period of 3 h, still have a specific surface area of at least 10 m²/g. MgAl₂O₄ obtainable according to the invention, for example, after thermal treatment in air at 750° C. for 1 h still has a specific surface area of at least 50 m²/g.

The invention further relates to materials having high specific surface areas which are obtainable by the method described above.

Because of their thermal stability, the inventive materials are suitable, for example, as support materials for catalysts, such as catalysts which are used at high temperatures. A possible field of use is motor vehicle catalysts which are used at operating temperatures between about 300 and 600° C.

The inventive method is, furthermore, suitable for directly producing supported catalysts having a metal component and an oxide support. In this embodiment, a suitable metal component is added to the production method, which then, after tempering, is present in the form of small metal particles in high dispersion on the oxide support material. The majority of the particles are preferably less than 20 nm in size. However, supported catalysts can also be produced in which the majority of the metal particles are smaller than 5 nm, or even smaller than 2 nm. The metal component, if appropriate, can be obtained by a reduction step from oxide particles of the corresponding sizes.

### EXAMPLES

These examples are intended only to illustrate the method and in no way to restrict it. Those skilled in the art are able, by a suitable selection of precursor compounds, matrices and treatment conditions, to produce other materials also having a high specific surface area and high thermal stability.

According to the inventive method, an activated carbon was impregnated with concentrated aluminum nitrate solution and the sample was then heated at 1300° C. under argon. Alternatively, other protective gases can also be used, for example other noble gases. The use of nitrogen can, in the case of aluminum oxide, lead to the formation of aluminum nitride, but nitrogen can be used as protective gas with other oxides. Those skilled in the art are able to make a suitable selection. The composite of carbon and the decomposition product of the aluminum nitrate, in an X-ray diffraction experiment, exclusively showed very broad reflections, which, surprisingly, cannot be assigned to α-aluminum oxide which is usually formed at temperatures above 1100° C., but to γ-aluminum oxide. The aluminum oxide which remains after the combustion of the carbon at 500° C. and subsequent tempering for 45 minutes at 600° C. has a specific surface area of 198 m²/g. After tempering at 1200° C. for 4 h, a mixture of alpha- and gamma-aluminum oxide is formed having a specific surface area of 14 m²/g. A pyrolysis of the aluminum nitrate-impregnated carbon at 1300° C. with access of air, in contrast, leads directly to alpha-aluminum oxide having a surface area of 1.8 m²/g. The advantage of the inventive method is clearly shown thereby.

As an example of materials which consist of mixtures of oxides, the method was applied to the mixture of ZrO₂/CeO₂, with a predominant ZrO₂ fraction. It was found that the resulting mixtures, after tempering for 3 hours at 1000° C. in the presence of air, still have a specific surface area of greater than 10 m²/g (examples 10-12).

By suitable choice of precursors, ternary oxides, such as MgAl₂O₄, having a high specific surface area and extreme thermal stability are also accessible. Here also, surface areas of greater than 150 m²/g are still achievable after tempering for 1 h at 750° C. in air (examples 7-9).

An MgAl₂O₄ spinel was produced by impregnating activated carbon with appropriately concentrated precursor solutions and tempering the carbon at 800° C. under protective gas. After combustion of the carbon at 500° C., the spinel had a specific surface area of 209 m²/g, and after tempering at 750° C. for 1 h the specific surface area was still 158 m²/g.

A sample impregnated with aluminum precursor and iridium(III) acetylacetonate was first heated at 1100° C. under protective gas. After combustion of the carbon in air at 500° C., a bluish-gray powder remained having a specific surface area of 323 m²/g. In the X-ray diffractogram, broad reflections of gamma-aluminum oxide and IrO₂ could be recognized. In the transmission electron microscope, particles of iridium and iridium oxide were to be seen at a size of about 1 nm dispersed over the entire aluminum oxide matrix, in addition to a few large particles having a size of about 50 nm.

### Example 1

### Impregnation of the Carbon with Aluminum Nitrate

58.87 g of Al(NO₃)₃.9H₂O were dissolved in 28.95 g of distilled water. 24 ml of this solution were admixed with 6.0 g of a vacuum-dehydrated activated carbon powder (Fluka 05120) and stirred for 10 min using a magnetic stirrer bar. The batch was then filtered off by suction in vacuo and the filter cake was mechanically pressed and dried for 1 h at 80° C. in a circulation oven.

Weight obtained: 17.4 g

### Example 2

### Aluminum Oxides after Calcining at 800° C. Under Protective Gas

4.2 g of the impregnated carbon from example 1 were charged into a quartz combustion boat and introduced into a quartz tube. The quartz tube was flushed with argon and heated to 800° C. in a tubular furnace at a heating rate of 4° C./min under a steady argon stream, and maintained at this temperature for 30 min. After the quartz tube was cooled to room temperature, the material was brought into contact with air and weighed.

Weight obtained: 1.31 g of a black powder

Pyrolysis of the carbon matrix: 1.13 g of the black powder were charged into an open quartz crucible and pyrolyzed in a muffle furnace with air contact for 2 hours at 500° C. (heating rate 4° C./min).

Weight obtained: 0.29 g of a virtually white powder

XRD: gamma-aluminum oxide

BET surface area: 356 m²/g

0.14 g of the material pyrolyzed at 500° C. were charged into an open quartz crucible and tempered for 15 hours at 1100° C. in a muffle furnace with air contact (heating rate 4° C./min).

Weight obtained: 0.14 g of a white powder)

XRD: gamma-aluminum oxide

BET surface area: 61 m²/g

### Example 3

### Aluminum Oxides after Calcining at 1100° C. Under Protective Gas

4.45 g of the impregnated carbon from example 1 were, as described in example 2, calcined under argon for 30 min at 1100° C.

Weight obtained: 1.32 g of a black powder

1.11 g of the black powder were pyrolyzed in the muffle furnace for 3 h at 500° C. with air contact.

Weight obtained: 0.28 g of a light-beige powder XRD: gamma-aluminum oxide

BET surface area: 323 m²/g

0.16 g of the light-beige powder were tempered for 1 h at 800° C. with air contact.

Weight obtained: 0.16 g

XRD: gamma-aluminum oxide

BET surface area: 241 m²/g

0.10 g of the light-beige powder pyrolyzed at 500° C. were tempered for 3 h at 1100° C. with air contact.

Weight obtained: 0.09 g of white powder

XRD: gamma-aluminum oxide

BET surface area: 86 m²/g

### Example 4

### Reference Experiment 1

2.95 g of the impregnated carbon from example 1 were charged into a quartz crucible and calcined for 30 min at 1100° C. with air contact (heating rate 4° C./min).

Weight obtained: 0.22 g of white powder

XRD: gamma-aluminum oxide

BET surface area: 39 m²/g

0.15 g of the white powder were tempered for 3 h at 1100° C. with air contact.

Weight obtained: 0.15 g of white powder

XRD: alpha- and gamma-aluminum oxide

BET surface area: 38 m²/g

### Example 5

### Reference Experiment 2

1.5 ml of the aqueous aluminum nitrate solution described under example 1 were calcined for 30 min at 1100° C. with air contact (without activated carbon!)—heating rate 4° C./min—

Weight obtained: 0.19 g of a white powder

XRD: alpha-aluminum oxide

BET surface area: 1.2 m²/g

### Example 6

### Aluminum Oxides after Calcining at 1300° C. Under Protective Gas

131 mg of the impregnated carbon from example 1 were held at 1300° C. for 2 hours under argon in a Thermal Analysis Unit from Netzsch (heating rate 4° C./min).

Pyrolysis of the carbon matrix: 3 h at 500° C. and 45 min at 650° C. in the muffle furnace with air contact.

Weight obtained: 0.03 g of a white powder

XRD: gamma-aluminum oxide

BET surface area: 198 m²/g

Study of Thermal Stability

Approximately 20 mg of the white powder were tempered for 4 h at 1200° C. with air contact.

Weight obtained: 18 mg of white powder

XRD: gamma- and alpha-aluminum oxide

BET surface area: 14 m²/g

### Example 7

### Reference Experiment 3

1.56 g of the impregnated carbon from example 1 were charged into a quartz crucible and calcined at 1300° C. with air contact in a high-temperature muffle furnace for 2 h (heating rate 4° C./min).

Weight obtained: 0.18 g of white powder

XRD: alpha-aluminum oxide

BET surface area: 1.8 m²/g

Comparison of example 6 with example 7 shows that even after a relatively long thermal load of the material, the oxide produced by the inventive method has a markedly higher specific surface area than the material known from the prior art.

### Example 8

### Impregnation of a Carbon with Magnesium Nitrate and Aluminum Nitrate

10.0 g of Mg(NO₃)₂.6H₂O and 29.26 g of Al(NO₃)₃.9H₂O were dissolved in 13.3 g of distilled water to give a colorless solution.

14 ml of this solution were admixed with 4.05 g of an activated carbon powder (Fluka 05120) dehydrated in vacuo, stirred at room temperature for 10 min, filtered off by suction in vacuo and the filter cake was mechanically pressed. The impregnated carbon was dried for 30 min at 80° C. in a circulation oven.

Weight obtained: 9.8 g of a black powder

### Example 9

### MgAl₂O₄ after Calcining at 800° C. Under Protective Gas

2.30 g of the impregnated carbon from example 7 were, as described in example 2, calcined for 1 h at 800° C. under argon in the tubular furnace.

Weight obtained: 0.86 g of black powder

Pyrolysis of the carbon matrix: 0.79 g of the black powder were pyrolyzed for 2 h at 500° C. in the muffle furnace with air contact (heating rate 4° C./min).

Weight obtained: 0.25 g of a light-beige powder

BET surface area: 209 m²/g

0.15 g of the light-beige powder were tempered for 1 h at 750° C. with air contact in the muffle furnace.

Weight obtained: 0.15 g of white powder

XRD: broad spinel reflections

BET surface area: 158 m²/g

### Example 10

### Reference Experiment 4

1.81 g of the impregnated carbon from example 7 were calcined for 1 h at 800° C. in the muffle furnace with air contact (heating rate 4° C./min).

Weight obtained: 0.20 g of white powder

XRD: broad spinel reflections

BET surface area: 103 m²/g

### Example 11

### Impregnating a Carbon with Zirconyl Nitrate and Cerium Nitrate

20 ml of a 35% strength by weight ZrO(NO₃)₂ solution in dilute HNO₃ (Aldrich) were mixed with 12.5 ml of a 1.5 molar Ce(NO₃)₄ solution (Alfa Aesar) (molar ratio Zr:Ce=70:30). 10 ml of this mixture were admixed with 2.40 g of an activated carbon (Fluka 05120) dehydrated in vacuo, stirred for 10 min at room temperature, filtered off by suction in vacuo, mechanically pressed and dried for 1 h at 80° C. in the circulation oven.

Weight obtained: 4.5 g of a black powder

### Example 12

### ZrO₂/CeO₂ after Calcining at 1100° C. Under Protective Gas

2.6 g of the impregnated carbon from example 10 were calcined for 30 min at 1100° C. under protective gas in the tubular furnace, as described in example 2 (heating rate 4° C./min).

Weight obtained: 1.47 g of black powder

Pyrolysis of the carbon matrix: 1.19 g of the black powder were pyrolyzed for 2 h at 500° C. in the muffle furnace with air contact (heating rate 4° C./min).

Weight obtained: 0.47 g of light-yellow powder

XRD: tetragonal zirconium oxide, broad reflections

BET surface area: 149 m²/g

0.18 g of the light-yellow powder were tempered for 3 h at 1000° C. in the muffle furnace with air contact (heating rate 4° C./min)

Weight obtained: 0.17 g of light-yellow powder

XRD: tetragonal zirconium oxide

BET surface area: 14.5 m²/g

### Example 13

### Reference Experiment 5

1.40 g of the impregnated carbon from example 10 were calcined at 1100° C. for 30 min in the muffle furnace with air contact (heating rate 4° C./min).

Weight obtained: 0.26 g of light-yellow powder

XRD: tetragonal zirconium oxide, possibly ZrₓCe_{y}O₂

BET surface area: 2.7 m²/g

### Example 14

### Impregnation of a Carbon with Chromium Nitrate

20.5 g of Cr(NO₃)₃.9H₂O (Fluka) were dissolved in 10 g of distilled water to give a deep-blue solution. 6.0 ml of the solution were admixed with 1.67 g of an activated carbon (Fluka 05120) dehydrated in vacuo and stirred at room temperature for 20 min. The batch was then filtered off by suction in vacuo, the filter cake was mechanically pressed and dried for 1 h at 80° C. in the circulation oven.

### Example 15

### Cr₂O₃ by Calcining at 450° C. Under Argon

The carbon impregnated under example 13 was transferred to a quartz combustion boat and calcined in a tubular furnace, and the carbon matrix was pyrolyzed. For this the material was heated to 450° C. under argon (heating rate 3° C./min) and calcined for 30 min under a steady argon stream. Then, at a constant furnace temperature, by introducing an argon-air mixture, the carbon matrix was combusted. By setting the air fraction, the sample temperature was a maximum 500° C. during the 1-hour course of pyrolysis.

Weight obtained: 0.52 g of green powder (sample was pyrophoric on first air contact.)

XRD: Cr₂O₃ (eskolaite)

BET surface area: 156 m²/g

### Example 16

### Reference Experiment 6

A carbon impregnated with Cr(NO₃)₃ (preparation as described in example 13, 1.61 g of activated carbon+6 ml of chromium(III) nitrate solution) was calcined for 1 h at 450° C. in the muffle furnace with air contact in an open porcelain dish.

Weight obtained: 0.51 g of grayish-green powder

BET surface area: 70 m²/g

### Example 17

### Impregnation of a Carbon with Aluminum Nitrate and Iridium(III) Acetylacetonate

2.70 g of the carbon impregnated with Al(NO₃)₃ from example 1 were admixed with a solution of 30 mg of iridium(III) acetylacetonate (Aldrich) in 1.5 ml of tetrahydrofuran, sitrred intensively and lightly ground in a mortar.

Weight obtained: 3.5 g of black powder

### Example 18

### Ir/Al₂O₃ by Calcining at 1100° C. Under Protective Gas

1.69 g of the impregnated carbon from example 16 were calcined for 30 min at 1100° C. under argon in the tubular furnace, as described in example 2 (heating rate 4° C./min).

Weight obtained: 0.76 g of a black powder

Pyrolysis of the carbon matrix: 0.69 g of the black powder was pyrolyzed for 2 h at 500° C. in the muffle furnace with air contact (heating rate 4° C./min).

Weight obtained: 0.19 g of bluish-gray powder

XRD: gamma-Al₂O₃ and broad IrO₂ reflections

BET surface area: 323 m²/g

TEM analysis: Uniform distribution of IrO₂ particles of size from 1 to 1.5 nm in the total sample, in addition, IrO₂ particles up to approximately 50 nm in size are situated on the surface.

80 mg of the bluish-gray powder were tempered for 3 h at 1000° C. (heating rate 4° C./min) in the muffle furnace with air contact.

Weight obtained: 70 mg of bluish-gray powder

BET surface area: 151 m²/g

### Example 19

### Reference Experiment 7

1.69 g of the impregnated carbon from example 16 was calcined for 30 min at 1100° C. in the muffle furnace with air contact (heating rate 4° C./min).

Weight obtained: 0.19 g of light grayish-green powder

XRD: gamma-aluminum oxide and sharp Ir+IrO₂ reflections

BET surface area: 92 m²/g

TEM: Ir/IrO2 particles approximately 20 to 500 nm in size, no particles in the 1 to 1.5 nm range

0.08 mg of the light grayish-green powder was tempered for 3 h at 1000° C. in the muffle furnace with air contact (heating rate 4° C./min).

Weight obtained: 0.08 g of light-gray powder

XRD: sharp IrO₂ reflections

BET surface area: 95 m²/g

### Example 20

### Impregnation of a Carbon with Zirconyl Nitrate

11.0 g of an activated carbon (Fluka 05120) dehydrated in vacuo were admixed with 18 ml of a ˜35% strength by weight ZrO(NO₃)₂ solution in dilute nitric acid (Aldrich), stirred intensively and lightly ground in a mortar. The resultant material was dried for 20 h at room temperature.

### Example 21

### Zirconium(IV) Oxide after Calcining at 1100° C. Under Protective Gas

18.2 g of the impregnated carbon from example 19 were, as described in example 2, calcined for 30 min at 1100° C. under argon in the tubular furnace. The remaining black powder was then pyrolyzed for 1 h at 650° C. with air contact in the muffle furnace (heating rate 4° C./min).

Weight obtained: 3.5 g of a weakly beige-pink powder

XRD: ZrO₂ reflections

BET surface area: 110 m²/g

1. A method for producing a material having a high specific surface area at high service temperature, the material, embedded in a matrix, selected from finely divided carbonaceous materials and/or silica gels, preferably being produced by thermal pretreatment, and the matrix then being removed, wherein the thermal pretreatment comprises heating to a temperature which is above the service temperature.

2. The method as claimed in claim 1, wherein the size of the material particles produced is upwards-limited by the matrix.

3. The method as claimed in claim 1, wherein the heating temperature is more than 100° C. above the service temperature.

4. The method as claimed in claim 1, wherein the matrix of finely divided carbonaceous materials is selected from activated carbon and ordered carbons.

5. The method as claimed in claim 4, wherein the thermal pretreatment is performed under protective gas, and the carbon matrix is removed by a reactive gas atmosphere after the thermal pretreatment at a lower temperature.

6. The method as claimed in claim 5, wherein the reactive gas atmosphere comprises oxygen.

7. The method as claimed in claim 1, wherein the material is an oxide.

8. The method as claimed in claim 7, wherein the oxide has a melting point above 1500° C.

9. The method as claimed in claim 7, wherein the oxide is an oxide of the elements Be, Mg, Ca, Sr, Ba, Al, Ga, Si, Mg, Ca, Sc, Y, La, Ti, Zr, Hf, V, Cr, Mn, Fe, Co, Ni, Zn, U, Th or the lanthanides or a mixture of such oxides.

10. A material having a high specific surface area at high service temperature, which material is obtainable by the means that the material, embedded in a matrix selected from finely divided carbonaceous materials and/or silica gels, is preferably produced by thermal pretreatment, and the matrix is then removed, the thermal pretreatment comprising a heating to a temperature which is above the service temperature.

11. The material as claimed in claim 10, which after thermal treatment in air at 1000° C. over a period of 3 h, still has a specific surface area of at least 10 m²/g.

12. A supported catalyst comprising the material as claimed in of claim 10.

13. The material as claimed in claim 10 which comprises an oxide component and a metal component, the particles of the metal component having in the majority sizes less than 20 nm, and the metal component, optionally, being further able to be obtained by a reduction step from oxide particles of the corresponding sizes.

14. The material as claimed in claim 10 which comprises particles of the metal component having in the majority sizes less than 5 nm.

15. The material as claimed in claim 11, which, after thermal treatment in air at 1000° C. over a period of 3 h, still has a specific surface area of at least 50 m²/g.

16. The material as claimed in claim 14, which comprises particles of the metal component having in the majority sizes less than 2 nm.

17. A method of producing a material having a high specific surface area at a high service temperature, said method comprising the following steps:
(a) producing the material embedded in a matrix by thermal pretreatment, the matrix being selected from the group consisting of finely divided carbonaceous materials, silica gels, and mixtures thereof; and
(b) removing the matrix;
wherein the thermal pretreatment comprises heating to a temperature which is above the service temperature.
